(19) United States
(12) Patent Application Publication
(10) Pub. No.: US 2004/0231304 A1
(43) Pub. Date: Nov. 25, 2004

(54) Increased flow air filter

(76) Inventor: Yi Ping Wang, Farmington Hills, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/442,479

(22) Filed: May 21, 2003

(51) Int. Cl. B01D 50/00

(52) U.S. Cl. 55/337; 55/418

(57) ABSTRACT

The present invention provides an air filter assembly including a first filter member having a tapered cylinder configuration, a first end with a first diameter, a second end with a second diameter, wherein the first diameter is greater than the second diameter, and is constructed of a first filtering material. The air filter assembly also includes a second filter member having a tapered cylinder configuration, a first end having a first diameter, a second end having a second diameter, wherein the first diameter is greater than the second diameter, and is constructed of a second filtering material. The first end of the first filter member is operably coupled to the first end of the second filter element.

### BACKGROUND OF THE INVENTION

The present invention pertains to a filtering device generally, and more specifically to an air filter which provides filtered air to an internal combustion engine.

Air filters and cleaners are used in a wide variety of application to provide a source of filtered air to, for example, an internal combustion engine. The purpose of these filters is to remove particles from the air or other medium that is being drawn through the filter, in order to supply the apparatus with air that is free of particles. Generally, these filters can be divided into two categories. The first category includes filters that are enclosed within a housing, where the air is drawn into the housing through an intake, passes through the filter, and then exits the housing to be used by the internal combustion engine. The second category of filters does not utilize a housing or an intake. Rather, air is drawn directly through the filter and then exits into the internal combustion engine.

These housing-less filters were originally designed to increase the supplied air flow by removing the restrictions caused by the housing by the housed filters, thereby allowing unrestricted movement of air to the filter, and providing more air flow through the filter. These filters are usually cylindrical in shape and allow air to be drawn in from all sides. This increase in the supplied air results in a greater efficiency of the internal combustion engine, providing benefits such as improved gas mileage.

Housing-less filters are generally connected to an internal combustion engine through an engine intake tube which is connected with one end of the filter. The transition between the air filter and the engine intake tube is typically abrupt, thereby significantly limiting intake air flow. The end of the filter opposite the intake tube is typically closed off to air flow, thereby adding an additional restriction and reducing the overall quantity of air that can be passed through the filtering medium. In order to avoid this restriction, filters have been developed which replace the closed end of the filter with a funnel, thereby allowing additional air flow into the filter through the funnel. However, one problem with this style filter is that the air flow entering and traveling through the funnel remains laminar. It is now generally understood that a turbulent air flow will provide additional benefits to an internal combustion engine.

Therefore, a need exists for an air filter which has an increased ability for air intake while simultaneously inducing turbulence in the air. Accordingly, an apparatus that solves the aforementioned disadvantages and having the aforementioned advantages is desired.

### SUMMARY OF THE PRESENT INVENTION

The present invention provides an air filter assembly including a first filter member having a tapered cylinder configuration, a first end with a first diameter and a second end with a second diameter, wherein the first diameter is greater than the second diameter, and is constructed of a first filtering material. The air filter assembly also includes a second filter member having a tapered cylinder configuration, a first end having a first diameter and a second end having a second diameter, wherein the first diameter is greater than the second diameter, and is constructed of a second filtering material. The first end of the first filter member is operably coupled to the first end of the second filter element, and a selected one of the second end of the first filter member and the second end of the second filter member is adapted to be coupled to an apparatus requiring a filtered medium.

Another aspect of the present invention is to provide an air filter assembly that includes a cylindrically-shaped filter member having a first end and a second end, and that is constructed of a filtering material. The air filter assembly also includes a funnel member comprising a first end having a first diameter and a second end having a second diameter. The funnel member further comprises at least one irregularity along a surface of the funnel member and is angularly disposed with respect to a centroidal axis of the funnel. The first end of the funnel member is operably coupled to the second end of the first filter member, and the second end of the funnel member is disposed within the filter member. The second end of the filter member is adapted to be operably coupled to an apparatus requiring a filtered medium.

In another aspect of the present invention, an air filter assembly includes a first filter member constructed of first filtering material and having a tapered cylinder configuration. The first filter member includes a first end having a first diameter and a second end having a second diameter, wherein the first diameter is greater than the second diameter. The air filter assembly also includes a second filter member having a tapered cylindrical configuration, a first end having a first diameter and a second end having a second diameter, wherein the first diameter is greater than the second diameter. The second filter member is constructed of a first or second filtering material. The first end of first filter member is operably coupled to the first end of the second filter element. The air filter assembly further includes a funnel member having a first end and a second end, wherein the first end has a first diameter and the second end has a second diameter. The first diameter of the funnel member is greater than the second diameter of the funnel member. The funnel member includes a plurality of outwardly-extending spaced-apart channels along a surface of the funnel member which are angularly disposed with respect to a centroidal axis of the funnel. The first end of the funnel member is operably coupled to the second end of the first filter member, and the second end of the second filter member is adapted to be coupled to an apparatus requiring a filtered medium.

The present inventive air filter assembly increases the efficiency of an associate engine, thereby increasing horsepower and allowing better fuel combustion resulting in decreased fuel consumption, is economical to manufacture, is adapted to be coupled to standard engine components, is capable of a long operating life, and is particularly well adapted for the proposed use of increased air flow to the associated engine.

These and other aspects, objects, and features of the present invention will be understood and appreciated by those skilled in the art upon studying the following specification, claims and appended drawings.

### BRIEF DESCRIPTION OF THE DRAWINGS

FIG. 1 is a perspective view of an air filter assembly according to the present invention;

FIG. 2 is an exploded perspective view of a first embodiment of the present invention;

FIG. 3 is a cross-sectional side view, excluding the funnel which is illustrated in its entirety, taken along line III-III of the exploded embodiment in FIG. 2; and

FIG. 4 is a perspective view of a second embodiment of the funnel member.

### DETAILED DESCRIPTION OF THE PREFERRED EMBODIMENT

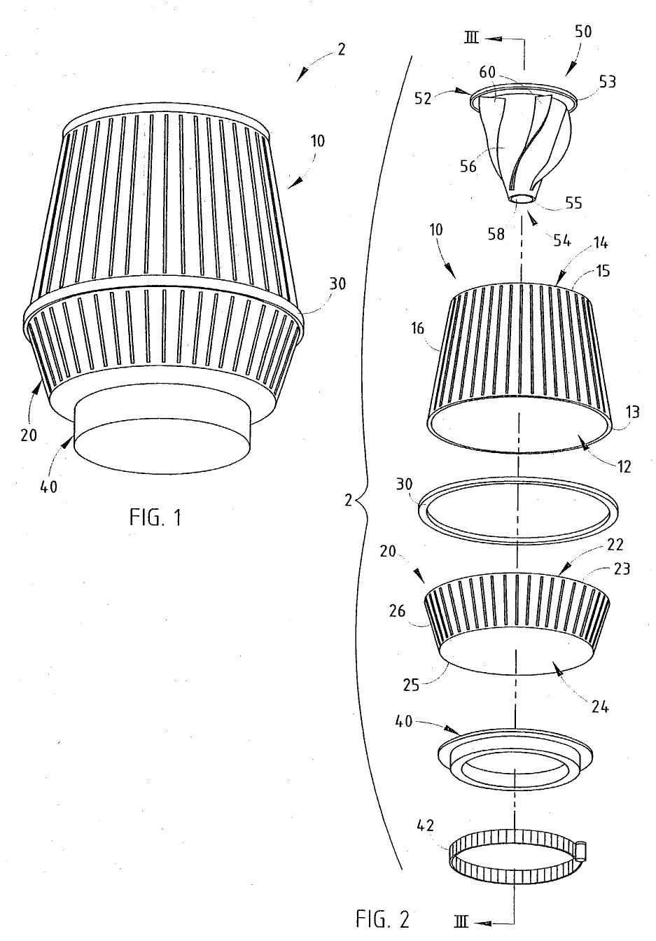

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 2 (FIG. 1) generally designates an air filter 2 embodying the present invention. The air filter 2 includes a first filter member 10 having a tapered cylinder configuration. The first filter member 10 includes a first end 12 (FIG. 2) having a first diameter 13 and a second end 14 having a second diameter 15, wherein the first diameter 13 is greater than the second diameter 15. The first filter member 10 is constructed of a pleated first filtering material 16 having a given air permeability. The air filter assembly 2 further includes a second filter member 20 having a tapered cylindrical configuration. The second filter member 20 includes a first end 22 having a first diameter 23 and a second end 24 having a second diameter 25, wherein the first diameter 23 is greater than the second diameter 25. The second filter member 20 is constructed of a pleated second filtering material 26 having a given air permeability. Preferably, the air permeability of the first filter member 10 is substantially similar to the air permeability of the second filter member 20, however, the air permeability of the first and second filter members 10, 20 may vary. The first end 12 of the first filter member 10 is operably coupled to the first end 22 of the second filter member 20. In the illustrated example, the diameter 13 of the first end 12 is substantially similar to the diameter 23 of the first end 22, however, other configurations may also be utilized, as described below. The second end 24 of the second filter member 20 is adapted to be coupled to an apparatus requiring a filtered medium.

In the illustrated example, the first filter member 10 and the second filter member 20 each have a tapered cylinder configuration, wherein the first diameter 13 of the first filter member 10 is larger than the second diameter 15 of the first filter member 10, and the first diameter 23 of the second filter member 20 is larger than the second diameter 25 of the second filter member 20. It should be noted that other geometrical configurations resulting in an increased filter surface area may also be utilized, as described below. The first diameter 13 is operably coupled to the first diameter 23 by a coupler 30. As illustrated, the coupler 30 is ring-shaped and which connects the first diameter 13 of the first filter member 10 to the first diameter 23 of the second filter member 20. The coupler 30 may couple the first filter member 10 and the second filter member 20 mechanically, adhesively, or through any other method generally known in the art.

In operation, air flow is increased by providing the second filter member 20 that acts as a transition zone, transitioning the first diameter 13 of the first filter member 10 to the diameter of the adapter 40, thereby providing an enlarged surface area capable of air intake allowing more air into the apparatus requiring the filtered air.

The adapter 40 is operably connected to the second end 24 of the second filter member 20 and provides a transition and a mount to enable the air filter assembly to be operably coupled to an apparatus which requires the filtered medium. The adapter 40 is a ring of pliable material operably connected to the second ends 24 of the air filter assembly 2. The opposite end of adapter 40 is connected to an intake of, for example, an internal combustion engine. In the illustrated example, the adapter 40 is operably connected to the internal combustion engine by the use of a clamp 42. However, the adapter 40 may be operably connected to any apparatus requiring a filtered medium, by any means known in the art including, but not limited to, clamping, screwing, and snapping. The other of the second end 14 or 22 of the air filter assembly 2 may be either closed off, or utilize a funnel 50 as described below.

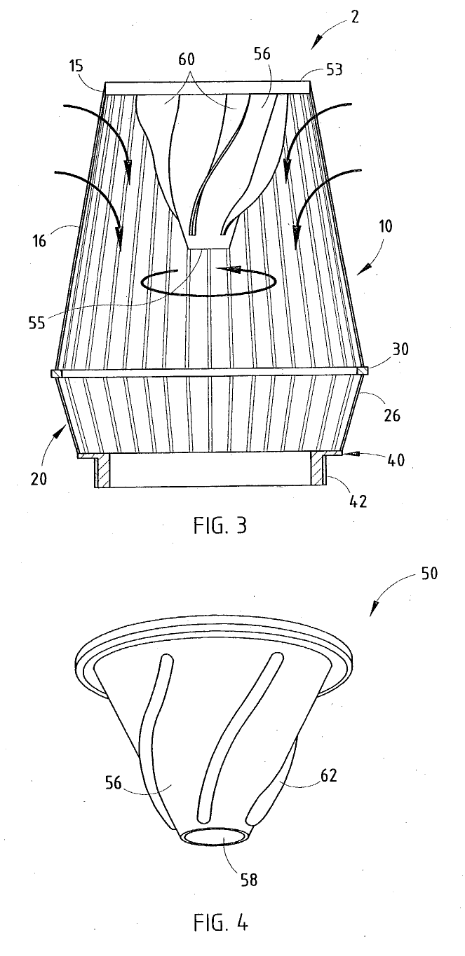

A funnel 50 is disposed within the second end 14 of the first filter member 10 and provides additional air intake. The funnel 50 includes a first end 52 having a first diameter 53 and second end 54 having a second diameter 55. The funnel 50 also includes an exterior surface 56 and an interior surface 58. A plurality of fins (FIGS. 2 and 3) 60 are provided on the exterior surface 56 of the funnel 50. The fins 60 extend outwardly from the exterior surface 56. It should be noted that the exterior surface 56 of the funnel 50 may include alternatively-shaped and positioned irregularities, such as grooves 62 (FIG. 4), channels, or any other protrusions or troughs which may help to facilitate the creation of turbulence within the incoming air flow. While the fins 60 extend the full distance between the first end 52 and the second end 54, the fins 60 or other irregularities may extend any portion thereof.

The first diameter 53 of the first end 52 of the funnel 50 is substantially the same as the second diameter 15 of the second end 14 of the first filter member 10. In addition, the second diameter 55 of the second end 54 of the funnel 50 is smaller than the first diameter 53 of the first end 52. In operation, air will enter the filter through the filtering material 16, 26 of the first filter member 10 and the second filter member 20 respectively, being induced by the apparatus requiring a filtered medium. Turbulence is then introduced into the entering air by the single or plurality of fins 60 on the exterior surface 56 of the funnel 50. It is also contemplated that a variety of embodiments can be used to achieve varying degrees of air flow and turbulence. For example, the second diameter 55 of the second end 54 of the funnel 50 could be zero to impart maximum rotation to the incoming air flow or alternatively, the funnel 50 may be provided with a single or plurality of fins 60 or other irregularities on its interior surface 58. In this manner, turbulence is introduced to air flowing through the interior of an open funnel 50. It is also contemplated, though not required, that with this embodiment an additional filter member could be added to cover the first diameter 53 of the first end 52 of the funnel 50 so that the additional supplied air would be filtered.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An air filter assembly, comprising:
a first filter member having a tapered cylinder configuration, the first filter member comprising a first end having a first diameter and a second end having a second diameter, wherein the first diameter is greater than the second diameter, the first filter member constructed of a first filtering material; and
a second filter member having a tapered cylindrical configuration, the second filter member comprising a first end having a first diameter and a second end having a second diameter, wherein the first diameter is greater than the second diameter, the second filter member constructed of a second filtering material;
wherein the first end of the first filter member is operably coupled to the first end of the second filter member, and wherein a selected one of the second end of the first filter member and the second end of the second filter member is adapted to be coupled to an apparatus requiring a filtered medium.

2. The air filter assembly as set forth in claim 1, wherein the second end of the first or the second end of the second filter member not adapted to be coupled to the apparatus is closed.

3. The air filter assembly as set forth in claim 1, wherein the first end diameter of the first filter member and the first end diameter of the second filter member are substantially equal.

4. The air filter assembly as set forth in claim 3, wherein the filtering materials have a substantially similar air permeability.

5. The air filter assembly as set forth in claim 4, further comprising:
a funnel member comprising a first end and a second end, the first end having a first diameter and the second end having a second diameter, the funnel member including at least one irregularity along a surface of the funnel member and angularly disposed with respect to a centroidal axis of the funnel; and
wherein the first end of the funnel member is operably coupled to the other end of the selected one of the second end of the first filter member and the second end of the second filter member, the second end of the funnel member being disposed within the first or second filter member.

6. The air filter assembly as set forth in claim 5, wherein the first diameter of the funnel member is greater than the second diameter of the funnel member.

7. The air filter assembly as set forth in claim 6, wherein the at least one irregularity extends outwardly from an exterior surface of the funnel.

8. The air filter assembly as set forth in claim 6, wherein the at least one irregularity includes a plurality of spaced apart grooves.

9. The air filter assembly as set forth in claim 8, wherein the grooves originate and terminate at the first and second diameter of the funnel.

10. The air filter assembly as set forth in claim 9, wherein the first end of the funnel member and the second end of the first filter member are substantially the same diameter.

11. The air filter assembly as set forth in claim 1, wherein the filtering materials have a substantially similar air permeability.

12. The air filter assembly as set forth in claim 1, further comprising:
a funnel member comprising a first end and a second end, the first end having a first diameter and the second end having a second diameter, the funnel member including at least one irregularity along a surface of the funnel member and angularly disposed with respect to a centroidal axis of the funnel; and
wherein the first end of the funnel member is operably coupled to the other end of the selected one of the second end of the first filter member and the second end of the second filter member, the second end of the funnel member being disposed within the first or second filter member.

13. An air filter assembly, comprising:
a cylindrically shaped filter member comprising a first end and second end and constructed of a filtering material; and
a funnel member comprising a first end and a second end, the first end having a first diameter and the second end having a second diameter, the funnel member comprising at least one irregularity along a surface of the funnel member and angularly disposed with respect to a centroidal axis of the funnel;
wherein the first end of the funnel member is operably coupled to the second end of the filter member, the second end of the funnel member being disposed within the filter member, and wherein the second end of the filter member is adapted to be operably coupled to an apparatus requiring a filtered medium.

14. The air filter assembly as set forth in claim 13, wherein the first diameter of the funnel member is greater than the second diameter of the funnel member.

15. The air filter assembly as set forth in claim 14, wherein the at least one irregularity extends outwardly from an exterior surface of the funnel.

16. The air filter assembly as set forth in claim 15, wherein the at least one irregularity originates and terminates at the first and second diameter of the funnel.

17. The air filter assembly as set forth in claim 15, wherein the at least one irregularity includes a plurality of spaced apart grooves.

18. The air filter assembly as set forth in claim 17, wherein the plurality of grooves originate and terminate at the first and second diameter of the funnel.

19. The air filter assembly as set forth in claim 18, wherein the first end of the funnel member and the first end of the filter member are substantially the same diameter.

20. The air filter assembly as set forth in claim 19, wherein the first end of the funnel member is covered with a filtering material.

21. The air filter assembly as set forth in claim 19, wherein the second end of the funnel member is closed.

22. The air filter assembly as set forth in claim 13, wherein the at least one irregularity extends inwardly from an interior surface of the funnel.

23. The air filter assembly as set forth in claim 13, wherein the at least one irregularity originates and terminates between at the first and second diameter of the funnel.

24. The air filter assembly as set forth in claim 13, wherein the at least one irregularity includes a plurality of spaced apart grooves disposed on the exterior surface of the funnel.

25. The air filter assembly as set forth in claim 24, wherein the plurality of grooves originate and terminate at the first and second diameter of the funnel.

26. The air filter assembly as set forth in claim 13, wherein the first end of the funnel member and the first end of the filter member are substantially the same diameter.

27. The air filter assembly as set forth in claim 13, wherein the first end of the funnel member is covered with a filtering material.

28. The air filter assembly as set forth in claim 13, wherein the second end of the funnel member closed.

29. The air filter assembly as set forth in claim 13, wherein the at least one irregularity includes a plurality of fins disposed on the exterior surface of the funnel.

30. An air filter assembly, comprising:
a first filter member constructed of a first filtering material and having a tapered cylinder configuration, the first filter member comprising a first end having a first diameter and a second end having a second diameter, wherein the first diameter is greater than the second diameter; a second filter member having a tapered cylindrical configuration, the second filter member comprising a first end having a first diameter and a second end having a second diameter, wherein the first diameter is greater than the second diameter, the second filter member constructed of a second filtering material, wherein the first end of the first filter member is operably coupled to the first end of the second filter element; and
a funnel member comprising a first end and a second end, the first end having a first diameter and the second end having a second diameter, wherein the first diameter of the funnel member is greater than the second diameter of the funnel member, the funnel member comprising a plurality of outwardly extending spaced-apart channels along a surface of the funnel member and angularly disposed with respect to a centroidal axis of the funnel;
wherein the first end of the funnel member-is operably coupled to the second end of the first filter member, and wherein the second end of the second filter member is adapted to be coupled to an apparatus requiring a filtered medium.

31. The air filter assembly as set forth in claim 30, wherein the first end diameter of the first filter member and the first end diameter of the second filter member are substantially equal.

32. The air filter assembly as set forth in claim 31, wherein the first end of the funnel member and the second end of the first filter member are substantially the same diameter.
